(19) United States
(12) Patent Application Publication
(10) Pub. No.: US 2024/0298191 A1
(43) Pub. Date: Sep. 5, 2024

(54) METHODS AND DEVICES FOR BEAM SELECTION

(71) Applicant: Telefonaktiebolaget LM Ericsson (PUBL), Stockholm (SE)

(72) Inventors: Muhammad Ali Kazmi, SUNDBYBERG (SE); Zhipeng Lin, NANJING (CN); Santhan Thangarasa, VÄLLINGBY (SE); Kazuyoshi Uesaka, KAWASAKI KANAGAWA (JP)

(21) Appl. No.: 18/550,485

(22) PCT Filed: Mar. 21, 2022
(86) PCT No.: PCT/IB2022/052555

§ 371 Date: Sep. 14, 2023

(30) Foreign Application Priority Data
Mar. 19, 2021 (CN) CN2021/081933

(51) Int. Cl. H04W 16/28; H04B 17/318; H04W 56/00; H04W 72/12; H04W 76/20

(52) U.S. Cl. CPC H04W 16/28; H04B 17/328; H04W 56/0045; H04W 72/12; H04W 76/20

(57) ABSTRACT

According to some embodiments, a method implemented by a first terminal device is provided. The method comprises: obtaining information about a first set of beams associated with configured resources for data transmission from a network node; obtaining a signal level threshold from the network node; and determining a second set of beams from the first set of beams based on at least the signal level threshold. The UE power consumption can be reduced for the CG based SDT, and the UE processing and complexity can also be reduced for the CG based SDT.

### TECHNICAL FIELD

The present disclosure generally relates to the field of beam selection, and more particularly to methods and devices for beam selection for data transmission.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

This section introduces aspects that may facilitate better understanding of the present disclosure. Accordingly, the statements of this section are to be read in this light and are not to be understood as admissions about what is in the prior art or what is not in the prior art.

5G (5th Generation) wireless networks support services that typically require only infrequent small data traffic. Examples of these services include traffic from instant messaging (IM) services, heart-beat traffic from instant messaging (IM)/email clients and other apps, push notifications from various applications, industrial wireless sensors transmitting temperature, pressure data periodically, etc.

NR (New Radio) supports an RRC_INACTIVE state and UEs (User Equipment) with infrequent (periodic and/or non-periodic) data transmission are generally maintained by a network in an RRC_CONNECTED state. Until NR Rel-16, the RRC_INACTIVE state does not support data transmission. Thus, the UE has to resume the connection (i.e., move to the RRC_CONNECTED state) for any DL (Downlink) and UL (Uplink) data.

Connection setup and subsequent release to the INACTIVE state happen for each data transmission regardless of how small and infrequent the data packets are. This results in unnecessary power consumption and signaling overhead. The signaling overhead for setting up connections before each transmission may be larger than a size of an actual data payload. To reduce the signaling overhead and improve UE battery life, NR Rel-17 may include small data transmission (SDT) in the RRC_INACTIVE state.

NR Rel-17 SDT may include two solutions for enabling SDT in the RRC_INACTIVE state: RACH (Random Access Channel) based SDT (i.e., transmitting small data on Message A PUSCH (Physical Uplink Shared Channel) in a 2-step RACH procedure, or transmitting small data on Message 3 PUSCH in a 4-step RACH procedure) and Configured Grant (CG) based SDT (i.e., SDT over configured grant type-1 PUSCH resources for UEs in the RRC inactive state).

The 2-step, 4-step RACH and configured grant type are specified as part of Rel-15 and Rel-16. Therefore, the SDT features specified in NR Rel-17 build on these building blocks to enable small data transmission in the INACTIVE state for NR.

The present disclosure focuses on the CG based SDT scheme. The CG based SDT scheme includes the following features.

CG-SDT resource configuration is provided to UEs in RRC_Connected only within the RRCRelease message, i.e., no need to also include it in an RRCReconfiguration message. CG-PUSCH resources can be separately configured for NUL (Normal Uplink) and SUL (Supplementary Uplink).

For CG-SDT, subsequent data transmission may use the CG resource or DG (i.e., dynamic grant addressed to UE's C-RNTI (Cell-Radio Network Temporary Identifier)). Details of the C-RNTI may be the same as those of a previous C-RNTI or may be configured explicitly by the network.

TAT-SDT (Time Alignment Timer-Small Data Transmission) is started upon receiving TAT-SDT configuration from gNB, i.e., an RRCrelease message, and may be (re)started upon reception of a TA (Time Alignment) command.

Similar to preconfigured uplink resources (PUR), NR R-17 may include a TA validation mechanism for the SDT based on RSRP (Reference Signal Receiving Power) change, i.e., RSRP-based threshold(s) are configured.

The UE releases CG-SDT resources when the TAT expires in the RRC_Inactive state.

The term CG-SDT may also interchangeably be referred to as PUR transmission because resources are also preconfigured for the CG-SDT transmission.

CG PUSCH resources are PUSCH resources configured in advance for the UE. When uplink data is available at a UE buffer, the UE may immediately start uplink transmission using the pre-configured PUSCH resources without waiting for an UL grant from the gNB, thereby reducing latency.

NR supports CG type 1 PUSCH transmission and CG type 2 PUSCH transmission. For both types, the PUSCH resources (time and frequency allocation, periodicity, etc.) are preconfigured via dedicated RRC signaling. The CG type 1 PUSCH transmission is activated/deactivated by the RRC signaling, while the CG type 2 PUSCH transmission is activated/deactivated by an UL grant using downlink control information (DCI) signaling.

Beamforming is important for improving coverage of synchronization signals (SSs) and physical broadcast channel (PBCH) block (referred to as SSB in 3GPP (Third Generation Partnership Project)) transmission, especially for compensating high path loss in high carrier frequency bands. To support beamforming and beam-sweeping for SSB transmission, a NR cell may transmit multiple SSBs in different narrow-beams in a time multiplexed fashion. The transmission of these SS/PBCH blocks is confined to a half frame time interval (5 ms).

FIG. 1 illustrates an example of SSB beam sweeping when the system is operating at a frequency range 1 (FR1). Each SSB is also interchangeably referred to as a beam, e.g. a DL beam, a DL reference signal beam, etc.

The maximum number of SSBs within a half frame (i.e., 5 ms), denoted by L, depends on the frequency band, and it is defined as follows:

In licensed FDD (frequency division duplex) bands, for carrier frequencies smaller than or equal to 3 GHz, L=4. For carrier frequencies larger than 3 GHz, L=8.

In licensed TDD (time division duplex) bands, for carrier frequencies smaller than or equal to 1.88 GHz, L=4. For carrier frequencies within FR1 larger than 1.88 GHz, L=8. For carrier frequencies within FR2, L=64.

One or more SSBs may be associated with each CG configuration for CG-SDT. For detail mapping or association between SSBs and CG configuration, at least two solutions are considered: one alternative is to reuse the SSB-to-RO mapping rule as much as possible, and the other alternative is to associate the CG resources per CG configuration with a set of SSB(s) that is explicitly configured for the CG configuration. Other solutions for mapping between SSB(s) and CG may also be considered.

CG configuration may comprise a set of CG resources, e.g., transmission occasions, DMRS (Demodulation Reference Signal), PUSCH resources (as described above for NR CG based PUSCH transmission), PUSCH repetitions, etc.

Slot aggregation for PUSCH is supported in Rel-15 and renamed to PUSCH Repetition Type A in Rel-16. The term PUSCH repetition Type A is used even if there is only a single repetition, i.e., no slot aggregation. In Rel-15, a PUSCH transmission that overlaps with DL symbols is not transmitted.

For DCI granted multi-slot transmission (PDSCH (Physical Downlink Shared Channel)/PUSCH) vs. semi-static DL/UL assignment, if semi-static DL/UL assignment configuration of a slot has no direction conflict with scheduled PDSCH/PUSCH assigned symbols, the PDSCH/PUSCH in that slot is received/transmitted. If semi-static DL/UL assignment configuration of a slot has direction conflict with scheduled PDSCH/PUSCH assigned symbols, the PDSCH/PUSCH transmission in that slot is not received/transmitted, i.e., the effective number of repetitions reduces.

In Rel-15, the number of repetitions is semi-statically configured by an RRC (Radio Resource Control) parameter pusch-AggregationFactor. At most 8 repetitions are supported.
pusch-AggregationFactor ENUMERATED {n2, n4, n8}.

A new repetition format, PUSCH repetition Type B, is supported in Rel-16, which provides back-to-back repetition of PUSCH transmissions. The main difference between the two types of repetition is that repetition Type A only provides a single repetition in each slot, with each repetition occupying the same symbols within the slot. Using Type A repetition, when a PUSCH repetition has a number of symbols shorter than 14 symbols, it introduces gaps between repetitions, increasing overall latency.

Another change compared to Rel-15 is how the number of repetitions is signaled. In Rel-15, the number of repetitions is semi-statically configured, while in Rel-16 the number of repetitions may be indicated dynamically in DCI. This applies both to dynamic grants and configured grants type 2.

In NR Rel-16, invalid symbols for PUSCH repetition Type B include reserved UL resources. The invalid symbol pattern indicator field is configured in the scheduling DCI. Segmentation occurs around symbols that are indicated as DL by the semi-static TDD pattern and invalid symbols.

The association between the one or more SSBs and the CG configuration of CG-SDT may be configured by the network (e.g., by a serving base station), along with other parameters (e.g., a TA value). A UE may be configured with a large number of SSBs, especially in FR2, because the total number of SSBs may be up to 64. Even in FR1, the UE may be configured up to 8 SSBs for almost all of the TDD bands. On one hand, this enables the UE to monitor a large number of beams and therefore increases the chance of successfully transmitting small data. On the other band, monitoring a large number of beams also increases UE power consumption. Currently, there is no mechanism to find good tradeoff between the UE power consumption and the monitoring of beams (e.g., SSBs) for small data transmission.

### SUMMARY

Particular embodiments include methods and devices for adapting monitoring of beams (e.g., synchronization signal blocks (SSBs)) which are associated with a configured grant (CG) configuration for small data transmission in a low activity state, e.g. in the radio resource control (RRC) inactive state, the RRC idle state, etc.

When a user equipment (UE) is configured with multiple beams (e.g., SSBs) that are associated with a CG configuration for small data transmission (SDT), the methods enable the UE to adaptively select a subset of beams for robust SDT transmission. This in turn reduces UE complexity and power consumption without delaying or degrading performance of the CG based SDT transmission.

According to a first aspect of the present disclosure, a method implemented by a first terminal device is provided. The method comprises: obtaining information about a first set of beams associated with configured resources for data transmission from a network node; obtaining a signal level threshold from the network node; and determining a second set of beams from the first set of beams based on at least the signal level threshold.

In an alternative embodiment of the first aspect, the method may further comprise: performing time alignment, TA, validation using beams in the second set of beams; and transmitting data using configured resources associated with the beams in the second set of beams in the case that the TA is valid.

In another alternative embodiment of the first aspect, the method may further comprise obtaining a minimum number of beams from the network node. The second set of beams is determined further based on the minimum number of beams.

According to a second aspect of the present disclosure, a method implemented by a second terminal device is provided. The method comprises: obtaining information about a first set of beams associated with first configured resources for data transmission from a network node; obtaining information about a second set of beams associated with second configured resources for the data transmission from the network node; determining whether the second terminal device is in a power saving mode; performing time alignment (TA) validation using beams in the first set of beams in response to determination that the second terminal device is not in the power saving mode, and using beams in the second set of beams in response to determination that the second terminal device is in the power saving mode; transmitting data using first configured resources associated with the first set of beams and using second configured resources associated with the second set of beams in the case that the TA is valid.

According to a third aspect of the present disclosure, a method implemented by a network node is provided. The method comprises: determining one or more beams for a first terminal device which performs the method of the first aspect or a second terminal device which performs the method of the second aspect to perform data transmission; and transmitting information about the one or more beams to the first terminal device or the second terminal device.

According to a fourth aspect of the present disclosure, a first terminal device is provided. The first terminal device comprises a processor and a memory communicatively coupled to the processor. The memory is adapted to store instructions which, when executed by the processor, cause the first terminal device to perform operations of the method according to the above first aspect.

According to a fifth aspect of the present disclosure, a first terminal device is provided. The first terminal device is adapted to perform the method of the above first aspect.

According to a sixth aspect of the present disclosure, a second terminal device is provided. The second terminal device comprises a processor and a memory communicatively coupled to the processor. The memory is adapted to store instructions which, when executed by the processor, cause the second terminal device to perform operations of the method according to the above second aspect.

According to a seventh aspect of the present disclosure, a second terminal device is provided. The second terminal device is adapted to perform the method of the above second aspect.

According to an eighth aspect of the present disclosure, a network node is provided. The network node comprises a processor and a memory communicatively coupled to the processor. The memory is adapted to store instructions which, when executed by the processor, cause the network node to perform operations of the method according to the above third aspect.

According to a ninth aspect of the present disclosure, a network node is provided. The network node is adapted to perform the method of the above third aspect.

According to a tenth aspect of the present disclosure, a wireless communication system is provided. The wireless communication system comprises a first terminal device of the above fourth or fifth aspect and a network node of the above eighth or ninth aspect communicating with at least the first terminal device.

According to an eleventh aspect of the present disclosure, a wireless communication system is provided. The wireless communication system comprises a second terminal device of the above sixth or seventh aspect and a network node of the above eighth or ninth aspect communicating with at least the second terminal device.

According to a twelfth aspect of the present disclosure, a non-transitory computer readable medium having a computer program stored thereon is provided. When the computer program is executed by a set of one or more processors of a first terminal device, the computer program causes the first terminal device to perform operations of the method according to the above first aspect.

According to a thirteenth aspect of the present disclosure, a non-transitory computer readable medium having a computer program stored thereon is provided. When the computer program is executed by a set of one or more processors of a second terminal device, the computer program causes the second terminal device to perform operations of the method according to the above second aspect.

According to a fourteenth aspect of the present disclosure, a non-transitory computer readable medium having a computer program stored thereon is provided. When the computer program is executed by a set of one or more processors of a network node, the computer program causes the network node to perform operations of the method according to the above third aspect.

According to particular embodiments, UE power consumption may be reduced for the CG based SDT, and UE processing and complexity may also be reduced for the CG based SDT. The signaling overhead may be reduced because the network does not need to modify or change the number of SSBs that are associated with the CG configuration. The UE autonomously determines a subset of SSBs for the SDT based on rules and configured thresholds disclosed herein.

### BRIEF DESCRIPTION OF THE DRAWINGS

The present disclosure may be best understood by way of example with reference to the following description and accompanying drawings that are used to illustrate embodiments of the present disclosure. In the drawings FIG. 1 is a diagram illustrating an example of SSB beam sweeping when the system is operating at FR1;

FIG. 2 is a flow chart illustrating UE selecting and using a subset of SSBs for TA validation based on a signal threshold according to the present disclosure;

FIG. 3 is a flow chart illustrating UE selecting and using a subset of beams for TA validation based on a signal threshold and a minimum set of beams according to the present disclosure;

FIG. 4 is a flow chart illustrating UE selecting and using subsets of beams for TA validation based on a power saving mode according to the present disclosure;

FIG. 5 is a flow chart illustrating a method implemented on a first terminal device according to some embodiments of the present disclosure;

FIG. 6 is a flow chart illustrating a method implemented on a second terminal device according to some embodiments of the present disclosure;

FIG. 7 is a flow chart illustrating a method implemented on a network node according to some embodiments of the present disclosure;

FIG. 8 is a block diagram illustrating a first terminal device according to some embodiments of the present disclosure;

FIG. 9 is another block diagram illustrating a first terminal device according to some embodiments of the present disclosure;

FIG. 10 is a block diagram illustrating a second terminal device according to some embodiments of the present disclosure;

FIG. 11 is another block diagram illustrating a second terminal device according to some embodiments of the present disclosure;

FIG. 12 is a block diagram illustrating a network node according to some embodiments of the present disclosure;

FIG. 13 is another block diagram illustrating a network node according to some embodiments of the present disclosure;

FIG. 14 is a block diagram illustrating a wireless communication system according to some embodiments of the present disclosure;

FIG. 15 is a block diagram illustrating a wireless communication system according to some embodiments of the present disclosure;

FIG. 16 is a block diagram schematically illustrating a telecommunication network connected via an intermediate network to a host computer;

FIG. 17 is a generalized block diagram of a host computer communicating via a base station with a user equipment over a partially wireless connection; and

FIGS. 18 to 21 are flowcharts illustrating methods implemented in a communication system including a host computer, a base station and a user equipment.

### DETAILED DESCRIPTION

The following detailed description describes methods and devices for beam selection for data transmission. In the following detailed description, numerous specific details such as logic implementations, types and interrelationships of system components, etc. are set forth to provide a more thorough understanding of the present disclosure. It should be appreciated, however, by one skilled in the art that the present disclosure may be practiced without such specific details. In other instances, control structures, circuits and instruction sequences have not been shown in detail to not obscure particular embodiments. Those of ordinary skill in the art, with the included descriptions, will be able to implement appropriate functionality without undue experimentation.

References in the specification to “one embodiment”, “an embodiment”, “an example embodiment” etc. indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments of the present disclosure. However, such notation should not be taken to mean that these are the only options or optional operations, and/or that blocks with solid borders are not optional in certain embodiments of the present disclosure.

In the following detailed description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, cooperate or interact with each other. “Connected” is used to indicate the establishment of communication between two or more elements that are coupled with each other.

An electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, read only memory (ROM), flash memory devices, phase change memory) and machine-readable transmission media (also referred to as a carrier) (e.g., electrical, optical, radio, acoustical or other forms of propagated signals—such as carrier waves, infrared signals). Thus, an electronic device (e.g., a computer) includes hardware and software, such as a set of one or more processors coupled to one or more machine-readable storage media to store code for execution on the set of processors and/or to store data.

For example, an electronic device may include non-volatile memory containing the code because the non-volatile memory can persist code/data even when the electronic device is turned off (when power is removed), and while the electronic device is turned on, that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set of one or more physical network interfaces to establish network connections (to transmit and/or receive code and/or data using propagating signals) with other electronic devices. One or more parts of an embodiment of the present disclosure may be implemented using different combinations of software, firmware, and/or hardware.

Even though in most of the embodiments described herein the selected beams (e.g., synchronization signal blocks (SSBs)) out of a larger set of beams (e.g., SSBs) are used for timing advance (TA) validation as an example, the present disclosure is related to how to determine the SSB beams for SDT in general and therefore the embodiments may be used for any SDT related purposes.

For example, some embodiments may be used for selecting configured grant (CG) resources for short data transmission (SDT), e.g., CG resources linked to the SSBs in a reduced/selected set of SSBs. Some embodiments may be used for reducing the number of SSBs to monitor for SDT. This reduces the user equipment (UE) complexity and/or power consumption. Some embodiments may be used for enabling the UE to monitor the most relevant SSBs for SDT. This also reduces the UE complexity and/or power consumption.

As used herein, the term “RRC (Radio Resource Control) release message” refers to a message to release RRC so that a UE will move from the RRC connected state to the RRC inactive state or the RRC idle state.

As used herein, the term “CG PUSCH configuration”, also known as “CG configuration” or “CG configured PUSCH”, refers to time, frequency and demodulation reference signal (DMRS) resource configurations in a configured grant for physical uplink shared channel (PUSCH) transmissions.

The terms “small data transmissions (SDT)” and “transmissions using preconfigured uplink resources (PUR)” may be interchangeably used. In this context, both refer to transmissions using preconfigured uplink resources in one or more uplink channels (e.g., PUSCH, PUCCH (Physical Uplink Control Channel), PRACH (Physical Random Access Channel)). In some examples, PUR and transmission using CG resources may be interchangeably used.

For particular examples and embodiments described herein, the scenario includes a UE operating in a first cell (cell1) served by a network node (NN), e.g., a gNB, a base station, an access point, etc. The UE is configured by the NN with configured grant (CG) resources for data transmission in a low activity state, e.g., the RRC idle state, the RRC inactive state, etc. The UE is further configured with timing advance related parameters or configuration, e.g., a TA value, a TA related timer such as a time alignment timer (TAT), etc. The CG resources or CG configuration may comprise one or more UL data channels (e.g., PUSCH) and each UL data channel may comprise one or more repetitions (e.g., PUSCH repetitions, etc.). The CG resources or CG configuration is associated with two or more downlink reference signals.

In one example, the UE may be configured with an association or relation or link between DL RSs (Reference Signals) (e.g., SSBs) and the CG resources in the same message containing CG configuration or in different messages. In another example, the association or relation or link between the DL RSs (e.g. SSBs) and the CG resources may be pre-defined or pre-configured in the UE.

Examples of the DL RS are SSB, CSI-RS (Channel State Information-Reference Signal), etc. Each DL RS is transmitted by the cell in one or more time-frequency resources. For example, one SSB is transmitted over 4 symbols and over 20 RBs (Resource Blocks), etc. Each DL RS (e.g. SSB) may interchangeably be referred to as a DL beam, a spatial filter, a spatial domain transmission filter, a main lobe of a radiation pattern of an antenna array, etc. The RS or beams may be addressed or configured by an identifier, which may indicate a location of the beam in time in a beam pattern, e.g., a beam index such as an SSB index indicates a SSB beam location in the pre-defined SSB format/pattern.

Before transmitting the small data to the network (e.g., in cell1), the UE first determines whether the configured TA is valid or invalid for uplink data transmission, e.g., CG-SDT. The UE typically performs the TA validation upon arrival of UL data in the UE buffer. The UE transmits the data using the configured CG resources provided that the TA is determined to be valid, otherwise the UE does not transmit data using the configured CG resources. The UE may check the validation of the TA using one or more TA validation mechanisms or methods, which may be pre-defined or configured by the network node:

One example method is based on a TA timer, e.g., TA is valid provided that the TAT is running, otherwise the TA is invalid. Another method is based on changes in the strongest beam, e.g., the strongest beam is the one with the largest RSRP of all the beams in the configured set. For example, if the strongest beam of the UE changes, then the TA becomes invalid, otherwise the TA is valid. In another example, if the strongest beam of the UE is changed but it still belongs to the configured set of the beams, then the TA is considered to be valid, otherwise the TA is considered to be invalid.

Yet another method is based on signal level change (e.g., RSRP change). In this case, for example, the TA is considered to be valid if the magnitude of the difference between the RSRP measured (RSRP1) at or around a time (T1) when the TA was configured and the RSRP measured (RSRP2) at or around a time (T2) when TA is being validated (for data transmission) is below or equal to a certain threshold (G), otherwise the TA is invalid. The RSRP may be a beam level or a cell level as explained below:

In one example, the RSRP used for RSRP based TA validation may be measured per beam (e.g., per SSB). In this case, the UE may check the TA validation for each beam separately. If the TA is valid for at least one beam based on its RSRP change (i.e., the magnitude of RSRP change the threshold for at least one beam) then the TA is valid, otherwise the TA is invalid.

In another example, the RSRP used for RSRP based TA validation may be measured on the cell level (e.g., an average RSRP of one or more SSBs). In this case, the UE may check the TA validation for all beams together, e.g., based on the average RSRP of all beams. If the magnitude of cell level RSRP change the threshold then the TA is valid, otherwise the TA is invalid.

The UE may further be configured (e.g., by the network via signaling or based on a pre-defined rule) to operate in a power saving mode (PSM) provided that the UE meets one or more criteria for the PSM. The criteria may be pre-defined and/or configured by the network. Examples of the PSMs are low mobility, not-at-cell edge, or both low mobility and not-at-cell edge, etc.

For example, the UE is in low mobility if the UE speed and/or Doppler frequency is below their thresholds. This may be determined by the UE based on changes in a measurement signal level (e.g., RSRP) over a certain time period, e.g., the UE meets low mobility criteria if change in the measured signal over the time period is below the threshold, otherwise it is not in low mobility. The UE is not-at-cell edge if the measured signal level is above the certain threshold, otherwise the UE is at the cell edge.

The UE may also be configured to operate in a specific type of PSM, e.g., in low mobility. If the UE is not operating in the PSM, then the UE operates in a normal mode or a legacy mode. When operating in the PSM, the UE may relax requirements for one or more procedures as compared to the requirements for the same procedures in the normal mode. Examples of the requirements are measurement times for procedures, e.g., a cell search, a measurement rate, etc. Examples of measurement time are a measurement period of a measurement (e.g., RSRP, RSRQ (Reference Signal Receiving Quality), etc.), a cell detection period (e.g., time to acquire a physical cell ID of a cell), an evaluation period, a cell reselection time, and a measurement rate which indicates how frequent the UE performs the measurements, etc.

For example, in the normal mode, a UE is required to perform a certain measurement (e.g., RSRP) over a measurement period (T0)=K1*TDRX cycle; K1≥1 e.g. K1=4. In the PSM, the UE is allowed to perform the same measurement over a measurement period (T1)=K2*K1*TDRX cycle, where K2 is a relaxation scaling factor, K2>1 e.g. K2=2 and K1=4. In one example, the parameter K2 is the same for two or more different types of PSM modes, e.g., the same K2 for low mobility and not-at-cell edge. In another example, the parameter K2 may further depend on the type of PSM mode, e.g., K2=K21 for low mobility and K2=K22 for not-at-cell edge, where K21≠K22.

In a first group of embodiments, a UE selects and uses a subset of beams for SDT, e.g., for TA validation based on a signal threshold. In a first embodiment, the UE is configured with a set (St) of beams (e.g., SSBs) that is associated with or linked or mapped to the CG configuration for small data transmission, and also with a signal threshold (H) (described below).

The set, St, may comprise a certain number of beams (Nt) (e.g., Nt SSBs) where Nt>1. Beam information within the set (e.g., St) may comprise identifiers of pre-defined information, e.g., a beam index, a beam configuration pattern or format, a frequency range, such as SSB indices in FR2 for SSB pattern Case D (defined in clause 4.1 of TS 38.213 v16.4.0), etc. The SSB index identifies an SSB within SS Burst, which is also referred to as a half frame (e.g., 5 ms). The UE is further configured with a signal threshold (H), e.g., pre-defined or configured by the network. The UE determines a subset of beams (Ss) from the set, St, based on at least the threshold H. The UE may further use one or more additional criteria (e.g., whether it is operating in the power saving mode or not, etc.) to determine the subset of beams, Ss, as explained further.

The UE uses the determined subset of beams in the set, Ss, for e.g. validating the TA before small data transmission using the configured CG resources. For example, the TA validation may be based on beam level RSRP (e.g., SSB based L1-RSRP) change and/or cell level RSRP (e.g., Layer 3 SS-RSRP) change as described above, or a TAT timer associated with the TA. The UE transmits the data using the CG resources if the TA is valid based on beams in subset Ss, otherwise the UE does not transmit the data using the CG resources associated with beams in Ss. As an example, Ss is a subset of St, i.e., (Ss⊂St) and (Ns<Nt).

In another example, the UE first uses the determined subset of beams in the set Ss, e.g., for validating the TA before small data transmission using the configured CG resources. If the TA is valid, then the UE transmits the data using the received SDT configuration/CG resources. However, if the TA is invalid based on beams in Ss, then the UE further uses the (original/initial) configured set of beams, St, for validating the TA. The UE transmits the data using the CG resources associated with beams in Ss if the TA is evaluated to be valid in the beams in the set Ss, otherwise the UE does not transmit the data using the CG resources associated with beams in Ss.

The UE adaptively determines the subset of beams, Ss, based on at least H using one or more of the following mechanisms:

In one example, the UE compares a signal level of each beam in the set St with the threshold H. A beam whose signal level is above H is included in the set Ss. Examples of signal levels are signal strengths (e.g., RSRP, etc.), a signal quality (e.g., RSRQ, SINR (Signal to Interference and plus Noise Ratio), SNR (Signal to Noise Ratio), etc.). The UE may measure signal levels of the beams periodically. For example, assume St contains 4 beams, St=(SSB0, SSB1, SSB2, SSB3) with RSRP levels corresponding to RSRP=(−89, −95, −85, −105) dBm respectively. When the H value is configured as −90 dBm, the UE determines the subset Ss based on H, comprising only 2 beams, i.e., Ss=(SSB0, SSB2). The UE uses only SSB0 and SSB2 for the TA validation.

In another example, the UE determines a subset, Ss, as in the example above only when the UE is operating in one of a set of power saving modes (PSMs) and uses beams in Ss for TA validation. However, if the UE is not operating in the power saving mode, then the UE uses beams in St for the TA validation. The UE may determine whether it is operating in the PSM if the UE meets criteria for that PSM. As a special case, the set of power saving modes may comprise one power saving operational mode. Examples of conditions in which the UE is in the PSMs are low mobility, not-at-cell edge, or both low mobility and not-at-cell edge, etc.

The UE determines the subset of beams, Ss, based at least on H at the following occasions. In one example, the UE determines the subset of beams, Ss, based on H, periodically. In another example, the UE determines the subset of beams, Ss, when the UE is configured for the SDT transmission, i.e., when PUR or CG resources are configured.

In another example, the UE determines the subset of beams, Ss, based on H only when the UE is triggered to perform the TA validation, e.g., before uplink data transmission using the CG resources. In another example, the UE determines the subset of beams, Ss, based on H when the signal level of one or more beams has changed by a certain margin.

In another example, the UE determines the subset of beams, Ss, based on H when the UE meets criteria for entering any type of power saving mode or for entering a particular type of PSM (e.g., low mobility, etc.). In another example, the UE determines the subset of beams, Ss, based on H when the UE meets criteria for leaving or exiting from any type of power saving mode or for leaving or exiting from a particular type of PSM (e.g., low mobility, etc.).

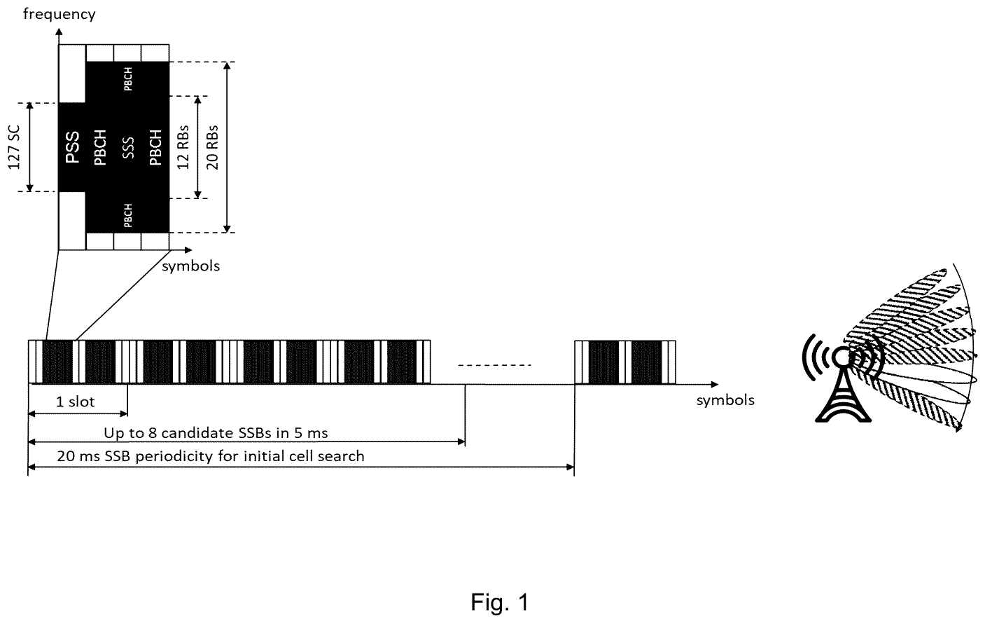

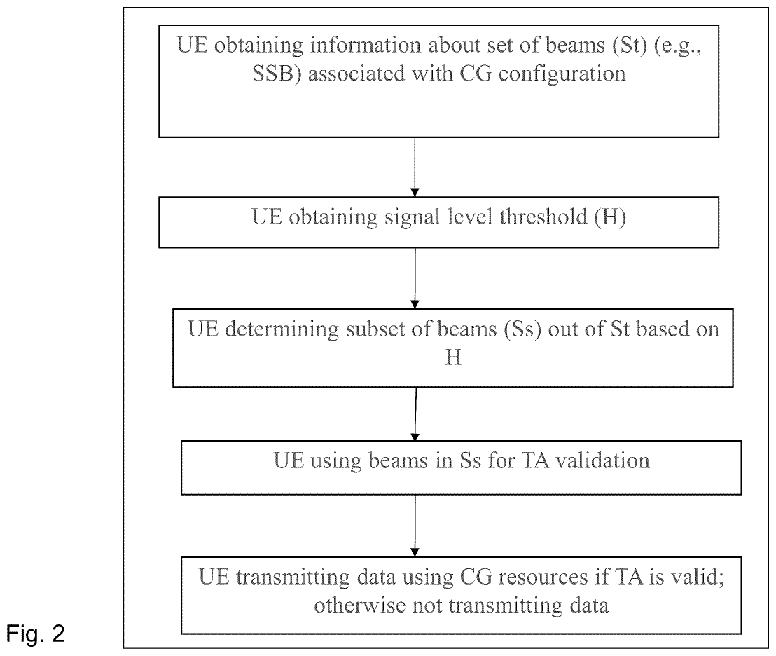

A high-level overview of the first group of embodiment is illustrated in FIG. 2.

A second group of embodiments includes a UE selecting and using a subset of beams for SDT, e.g., for TA validation on a signal threshold and a minimum set of beams. In a second embodiment, the UE is also configured with a set (St) of beams (e.g., SSBs) that is associated with or linked or mapped to the CG configuration for small data transmission, a threshold, H, and a minimum number of beams (Nmin) (described below). The set, St, may comprise a certain number of beams (Nt) (e.g., Nt SSBs) where Nt>1. The beam information within the set (e.g., St) may comprise identifiers of pre-defined beams or beam patterns, e.g., a beam index, a beam configuration pattern or format, a frequency range, such as SSB indices in FR2 for SSB pattern Case D, etc. The UE is further configured with a signal threshold (H) and a minimum number of beams (Nmin) where Nmin Nt.

The UE determines a minimum set (Smin) of beams (Nmin) (e.g., Nmin number of SSBs) out of the set of Nt beams based on at least H. The UE may further use one or more additional criteria (e.g., the strongest beams, when in a power saving mode, etc.) for determining the set, Smin. In some scenarios, the minimum set of beams, Smin, may enable the UE to use even fewer beams for the TA validation than those used in the first group of embodiments.

The UE uses the determined minimum subset of beams in the set, Smin, for validating the TA before the small data transmission using the configured CG resources. For example, the TA validation may be based on beam level RSRP change or cell level RSRP change or any other type of TA validation methods such as a TAT timer-based method as described above. The UE transmits the data using the CG resources if the TA is valid based on beams in the minimum subset Smin, otherwise the UE does not transmit the data using the CG resources associated with beams in Smin.

In another example, the UE first uses the determined minimum subset of beams in the set, Smin, for validating the TA before the small data transmission using the configured CG resources. If the TA is valid, then the UE transmits the data using the CG resources associated with beams in Smin. However, if the TA is invalid based on beams in Smin, then the UE further uses all beams in the (original/initial) configured set of beams, St, for validating the TA. The UE transmits the data using the CG resources associated with beams in St if the TA is valid; otherwise the UE does not transmit the data using the CG resources associated with beams in St.

The UE adaptively determines the subset of beams, Ss, based at least on Nmin and H using one or more of the following mechanisms. In one example, the UE compares a signal level of each beam in the set, St, with a threshold, H. A beam with a signal level above H is included in the set Smin and up to Nmin number of beams are included in the set Smin. As an example, the UE includes only Nmin number of strongest beams (e.g., beams with the largest RSRP) if the signal levels of more than Nmin number of beams are above H. For example, assume St contains 5 beams, St=(SSB0, SSB1, SSB2, SSB3, SSB4) with RSRP levels corresponding to RSRP=(−89, −95, −85, −105, −88) dBm respectively. The H value is −90 dBm and Nmin=2. In this case, the UE determines that signal levels of beams SSB0, SSB2 and SSB4 are above H (−90 dBm). However, since Nmin=2, the UE reduces the candidate SSBs further to meet Nmin and therefore the set Smin may comprise only 2 strongest beams, i.e., Smin=(SSB2, SSB4). The UE uses only SSB2 and SSB4 for the TA validation.

In another example, the UE determines a minimum subset, Smin, as in the first group of embodiments described above only when the UE is operating in one of a set of power saving modes (PSMs) and uses beams in Ss for the TA validation. However, if the UE is not operating in the power saving mode, then the UE uses beams in St for the TA validation. The UE may determine whether it is operating in the PSM if the UE meets criteria for that PSM. As a special case, the set of power saving modes may comprise one power saving operational mode. Examples of conditions in which the UE is in the PSMs are low mobility, not-at-cell edge, both low mobility and not-at-cell edge, etc.

The UE determines the minimum subset of beams, Smin, based at least on Nmin and H at the following occasions. In one example, the UE determines Smin based on Nmin and H, periodically. In another example, the UE determines Smin based on Nmin and H when UE is configured for the SDT transmission, i.e., when PUR or CG resources are configured.

In another example, the UE determines Smin based on Nmin and H only when the UE is triggered to perform the TA validation, e.g., before uplink data transmission using the CG resources. In another example, the UE determines Smin based on Nmin and H when the signal levels of one or more beams have changed by a certain margin.

In another example, the UE determines Smin based on Nmin and H when the UE meets criteria for entering any type of power saving mode or for entering a particular type of PSM (e.g., low mobility, etc.). In another example, the UE determines Smin based on Nmin and H when the UE meets criteria for leaving or exiting from any type of power saving mode or for leaving or exiting from a particular type of PSM (e.g., low mobility, etc.).

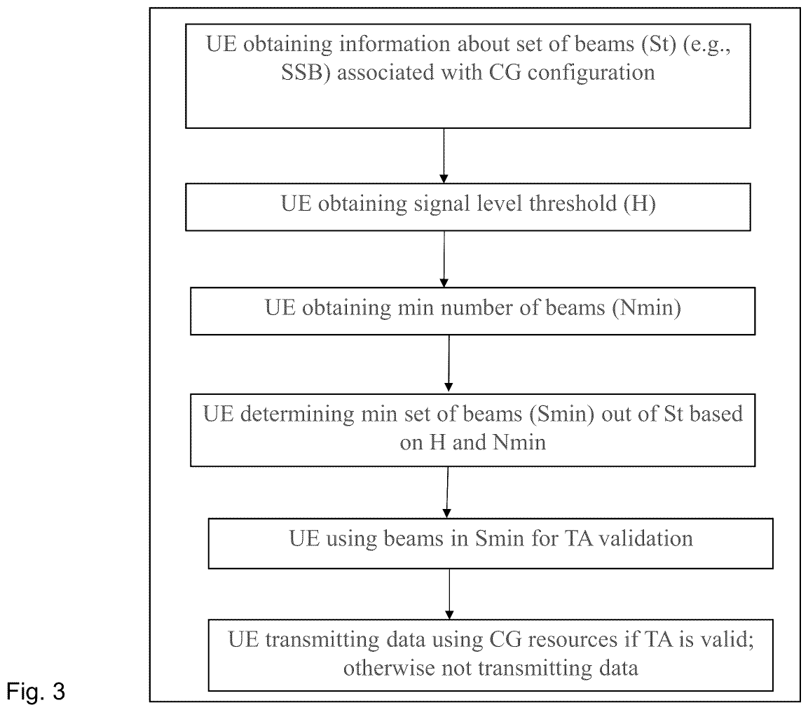

A high level overview of the second embodiment is illustrated in FIG. 3.

In a third group of embodiments, a UE selects and uses subsets of beams for SDT, e.g., for TA validation based on power saving operational modes. In a third embodiment, the UE is configured with a set (St) of beams (e.g., SSBs) which is associated with or linked or mapped to a first CG (CG1) configuration for the small data transmission. The set, St, may comprise a certain number of beams (Nt) (e.g., Nt SSBs) where Nt>1. The UE is further configured with another set (Sp) of beams which is also associated with or linked or mapped to a second CG configuration (CG2) for the small data transmission. The set, Sp, may comprise a certain number of beams (Np) (e.g., Np SSBs) where Np>1. The UE may further be configured with the set of beams specific to a power saving mode, e.g., a set of beams Sp1 and a set of beams Sp2 for low mobility and not-at-cell edge respectively. Sp1 and Sp2 may comprise a number of beams Np1 and Np2 respectively. The beam information within each set (e.g., St or Sp) may comprise identifiers of pre-defined information, e.g., a beam index, a beam configuration pattern or format, a frequency range, such as SSB indices in FR2 for SSB pattern Case D, etc.

In one example, the sets St and Sp are related to each other, for example, Sp∈St, e.g., Sp is a subset of St. For example, St=(SSB0, SSB1, SSB2, SSB3) and Sp=(SSB0, SSB2). In another example, the sets St and Sp are independent from or not related to each other. For example, Sp and St may comprise different beams, or some but not all beams may be the same, e.g., St=(SSB0, SSB1, SSB2, SSB3) and Sp=(SSB0, SSB4).

In one example, CG1 and CG2 are different. In another example, CG1 and CG2 are the same.

The UE uses the beams in different sets (St or Sp) for the TA validation as follows. In some embodiments, the set of beams in the set St are used by the UE for the TA validation when the UE is not configured in the power saving mode (PSM) or when the UE is operating in a normal mode (a legacy mode, a non-PSM mode). If the UE is not configured to operate in the PSM, then the UE is in the normal mode, e.g., when the UE has not received any indication from the network node for operating in the PSM. If the UE is configured to operate in the PSM but it does not meet criteria for any PSM, then the UE is also in the normal mode.

In some embodiments, the set of beams in the set Sp are used by the UE for the TA validation when the UE is configured in the power saving mode (PSM) or when the UE is operating in the PSM (e.g., when the UE actually meets the criteria for a certain PSM). For example, the UE may determine whether the UE is explicitly configured by the network node for allowing the UE to operate in the PSM. In one example, if the UE is configured with the PSM regardless of whether it actually meets the PSM criteria, then the UE may use beams in the set Sp for the TA validation, otherwise it may use beams in the set St for the TA validation.

In another example, if the UE meets criteria for any PSM, then the UE may use beams in the set Sp for the TA validation, otherwise it may use beams in the set St for the TA validation. If the UE is configured with a set of beams specific to a PSM, then for the TA validation the UE uses the set of beams related to PSM in which the UE is determined to be operating (e.g., for which the UE has met criteria).

The UE uses the beams in the determined set (as described above) for validating the TA before the small data transmission using the configured CG resources, e.g., CG1 if the set is St or CG2 if the set is Sp. For example, the TA validation may be based on beam level RSRP change or cell level RSRP change as described above. The UE transmits the data using the CG resources if the TA is valid based on beams in determined set, otherwise the UE does not transmit the data using CG resources.

In another example, the UE first uses the beams in the determined set for validating the TA before the small data transmission using the configured CG resources. If the TA is valid, then the UE transmits the data. However, if the TA is invalid based on beams in first determined set, then the UE further uses beams in the other set for validating the TA. The UE transmits the data using the CG resources associated with Sp if the TA is valid, otherwise the UE does not transmit the data using the CG resources associated with Sp. For example, assume that the UE is in the PSM and therefore it first uses beams in the set, Sp, for the TA validation. The UE determines that the TA is invalid based on beams in Sp. In this case, the UE further uses the beams in the set, St, for the TA validation even though the UE is in the PSM. If the TA is valid based on beams in the set St, then the UE transmits the data using the CG resources associated with St, otherwise the UE does not transmit the data using the CG resources associated with St.

In some embodiments, the UE power saving mode for the SDT may be determined based on one or more of the following methods. The power saving mode configuration for the SDT may be based on the configurations when UE was in the RRC connected state. The power saving mode configuration for the SDT may be separately configured. For example, a PSM configuration may be configured in the RRC release message. The power saving mode configuration may be determined based on other parameters, e.g., an estimated UE speed based on the signal measurement on downlink, a TA value or variation of the TA value, and/or a UE capability on the PSM reported when the UE was in the RRC connected state.

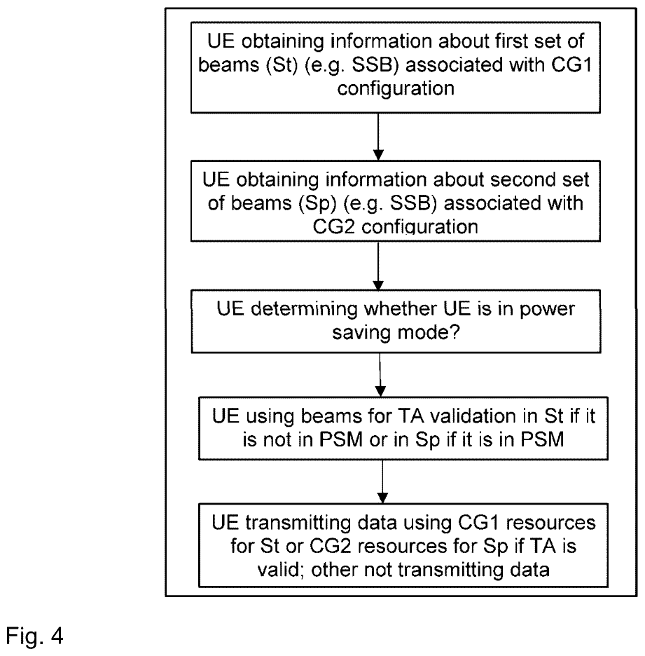

A high level overview of the third embodiment is illustrated in FIG. 4.

Embodiment #4: the network selecting beams for SDT

In a fourth group of embodiments, the network node determines one or more beams (e.g., SSB beams) to be used for a UE to perform the SDT according to one or more of the following factors or criteria or conditions. The network node may determine one or more beams according to a total number of beams (e.g. SSBs) configured by the network node (e.g., in SIB1). For example, the SSBs selected for the SDT should be at least a subset of the SSB cell specifically configured in SIB1.

The network node may determine one or more beams according to one or more of the SSBs selected by the UE when the UE was in the RRC connected state. For example, the SSBs selected for beam association may be the latest SSB selected by the UE before the UE switches to the RRC inactive state.

The network node may determine one or more beams according to one or more of the SSBs that cover the area covered by the CSI-RS beam selected by the UE before the UE switches to the RRC inactive state.

The network node may determine one or more beams according to a number of CG PUSCH configurations configured for the SDT. For example, the number of the SSBs should not be more than the number of the CG PUSCH configurations.

The network node may determine one or more beams according to the frequency of the beam change before the UE switches to the RRC inactive state. For example, if the UE changes the selected SSB more frequently, such as more than a defined number of times of beam switching, more SSBs are configured for the SDT in the RRC inactive state for this UE, otherwise, a fewer number of SSBs may be configured for the SDT of this UE.

Another example is that if a large number (more than a predetermined number) of beam failure detections is detected by the network node from this UE, a greater number of beams may be configured for this UE to perform the SDT.

The beams comprising the beams determined by the network node based on the above principles are included in a set, Sb. In one example, Sb is the same as the set St in the previous first, second and/or third embodiments. In another example, St is different than or not fully identical to the set St in the previous first, second and/or third embodiments. In another example, Sb is the same as the set Sp in the third embodiment.

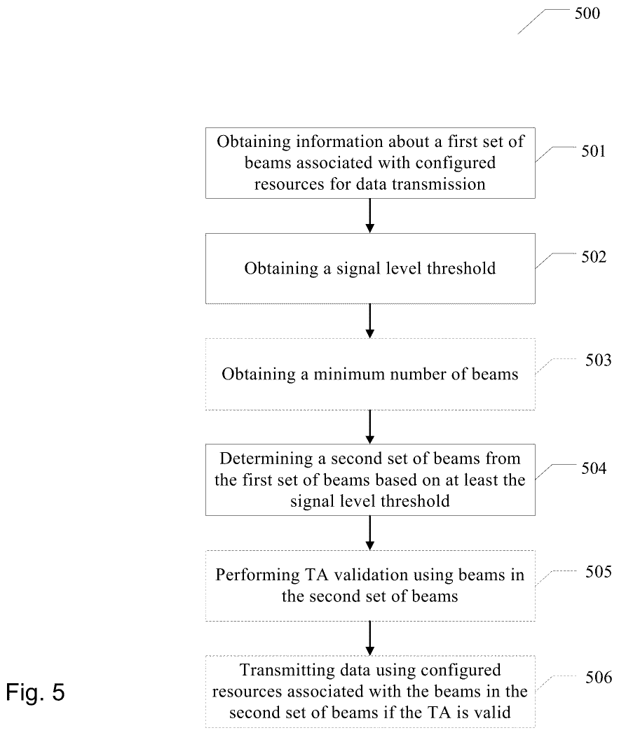

FIG. 5 is a flow chart illustrating a method 500 implemented on a first terminal device according to some embodiments of the present disclosure. As an example, operations of this flow chart may be performed by a UE in the above first or second embodiment illustrated in FIG. 2 or 3, but they are not limited thereto. The operations in this and other flow charts will be described with reference to the example embodiments of the other figures. However, it should be appreciated that the operations of the flow charts may be performed by embodiments of the present disclosure other than those discussed with reference to the other figures, and the embodiments of the present disclosure discussed with reference to these other figures may perform operations different than those discussed with reference to the flow charts.

In one embodiment, the UE may obtain information about a first set of beams associated with configured resources for data transmission from a network node (block 501). Then, the UE may obtain a signal level threshold from the network node (block 502).

As an optional example, the UE may obtain a minimum number of beams from the network node (block 503). The second set of beams may be determined based on the signal level threshold and the minimum number of beams.

The UE may determine a second set of beams from the first set of beams based on at least the signal level threshold (block 504).

As another optional example, the UE may perform TA validation using beams in the second set of beams (block 505), and transmit data using configured resources associated with the beams in the second set of beams in the case that the TA is valid (block 506).

As an example, the configured resources may comprise a CG configuration for SDT.

As an example, the information may comprise beam indices, beam configuration patterns and/or frequency ranges.

As a further example, the TA validation may be based on an RSRP change and/or a cell level RSRP change or based on a TA timer associated with the TA.

As a further example, in the case that the TA is invalid, the data may not be transmitted using the configured resources associated with the beams in the second set of beams.

As a further example, the method 500 may further comprise, in the case that the TA is invalid, performing the TA validation using beams in the first set of beams.

As an example, the second set of beams may be determined by comparing a signal level of each beam in the first set of beams to the signal level threshold and including a beam having a signal level above the signal level threshold in the second set of beams. As a further example, the signal level may include a signal strength or a signal quality. As a further example, the signal level may be measured by the UE periodically.

As an example, the second set of beams may be determined only when the UE is operating in one of one or more power saving modes.

As a further example, the method 500 may further comprise, in the case that the UE is not operating in any of the power saving modes, performing the TA validation using beams in the first set of beams. As a further example, conditions in which the UE is in a power saving mode may include low mobility, not-at-cell edge, or both low mobility and not-at-cell edge.

As an example, the second set of beams may be determined periodically. As an example, the second set of beams may be determined when the UE is configured for the data transmission. As an example, the second set of beams may be determined only when the UE is triggered to perform the TA validation. As an example, the second set of beams may be determined when signal levels of one or more beams of the first set of beams have changed by a predetermined margin. As an example, the second set of beams may be determined when the UE meets criteria for entering any type of power saving mode or a predetermined type of power saving mode. As an example, the second set of beams may be determined when the UE meets criteria for exiting from any type of power saving mode or a predetermined type of power saving mode.

As an example, the second set of beams may be a subset of the first set of beams. As a further example, the number of beams in the second set of beams may be the minimum number.

As an example, the network node may be a gNB, a base station or an access point.

Furthermore, the present disclosure provides a first terminal device which is adapted to perform the method 500.

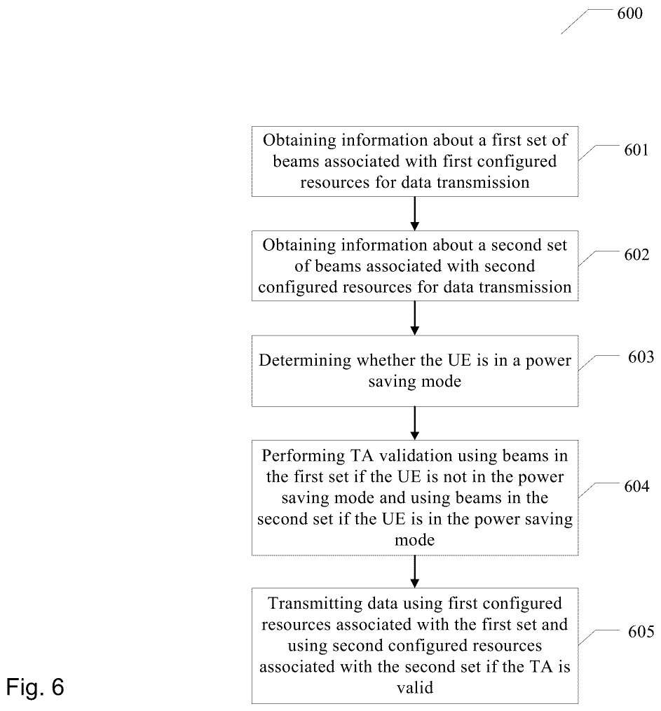

FIG. 6 is a flow chart illustrating a method 600 implemented on a second terminal device according to some embodiments of the present disclosure. As an example, operations of this flow chart may be performed by a UE in the third embodiment illustrated in FIG. 4.

In one embodiment, the UE may obtain information about a first set of beams associated with first configured resources for data transmission from a network node (block 601). The UE may also obtain information about a second set of beams associated with second configured resources for the data transmission from the network node (block 602). Then, the UE may determine whether it is in a power saving mode (block 603). The UE may perform TA validation using beams in the first set of beams if the UE is not in the power saving mode and using beams in the second set of beams if the UE is in the power saving mode (block 604). The UE may transmit data using first configured resources associated with the first set of beams and using second configured resources associated with the second set of beams in the case that the TA is valid (block 605).

As an example, the first configured resources may comprise a first CG configuration for SDT and the second configured resources may comprise a second CG configuration for the SDT.

As an example, the information may comprise beam indices, beam configuration patterns and/or frequency ranges.

As an example, conditions in which the UE is in the power saving mode may include low mobility, not-at-cell edge, or both low mobility and not-at-cell edge.

As an example, the first set of beams may be related to the second set of beams. As a further example, the second set of beams may be a subset of the first set of beams. As an example, the first set of beams may be independent from the second set of beams. As a further example, beams in the first set of beams and in the second set of beams may be partially different. As an example, the first configured resources may be the same as or different from the second configured resources.

As an example, the first set of beams may be used for the TA validation in the case the UE is operating in a normal mode. As a further example, the normal mode may be a mode in which the UE is not configured to operate in the power saving mode, or in which the UE is configured to operate in the power saving mode but does not meet criteria for the power saving mode. As an example, the second set of beams may be used for the TA validation in the case that the UE may be configured to operate in the power saving mode regardless of whether the UE meets criteria for the power saving mode.

As an example, the method 600 may further comprise, in the case that the UE is configured with sets of beams specific to power saving modes, performing the TA validation using the set of claims associated with the power saving mode in which the UE is to be operating.

As an example, the TA validation may be based on a beam level RSRP change and/or a cell level RSRP change.

As an example, in the case that the TA is invalid, the data may not be transmitted using the configured resources associated with the beams in the first set of beams or the second set of beams.

As an example, the method 600 may further comprise, in the case that the TA is invalid for one of the first set of beams and the second set of beams, performing TA validation using the other of the first set of beams and the second set of beams and transmitting the data using the other set of beams in the case that the TA is valid for the other set of beams.

As an example, a configuration of the power saving mode for the data transmission is determined based on at least one of: a configuration of the UE which is in an RRC connected state; a separate configuration in an RRC release message; an estimated speed of the UE based on signal measurement on downlink; a TA value or variation of the TA value; and a capability of the UE for the power saving mode reported when the UE was in the RRC connected state.

As an example, the network node may comprise a gNB, a base station or an access point.

Furthermore, the present disclosure provides a second terminal device which is adapted to perform the method 600.

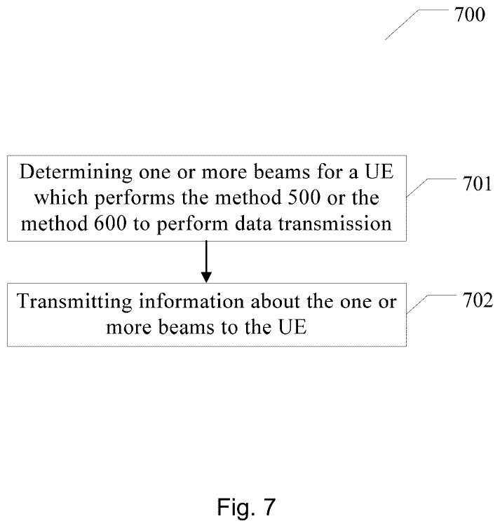

FIG. 7 is a flow chart illustrating a method 700 implemented on a terminal node according to some embodiments of the present disclosure. As an example, operations of this flow chart may be performed by a network node in the above fourth embodiment.

In one embodiment, the network node may determine one or more beams for a UE which performs the method 500 of FIG. 5 or the method 600 of FIG. 6 to perform data transmission (block 701). The network node may transmit information about the one or more beams to the UE (block 702). As an example, the data transmission may be SDT.

As an example, the one or more beams may be determined based on at least one of: a total number of beams configured by the network node; one or more blocks comprising SSBs selected by the UE in an RRC connected state; one or more SSBs which cover an area covered by a CSI-RS beam selected by the UE prior to switching to an RRC inactive state; the number of CG PUSCH configurations configured for the data transmission; and/or a frequency of beam change before the UE switches to the RRC inactive state.

As an example, the one or more beams determined by the network node may be included in a set of beams which is the same as, different from or partially different from one of: the first set of beams involved in the method 500 of FIG. 5; the first set of beams involved in the method 600 of FIG. 6; and the second set of beams involved in the method 600 of FIG. 6.

As an example, the network node may comprise a gNB, a base station or an access point.

Furthermore, the present disclosure provides a network node which is adapted to perform the method 700.

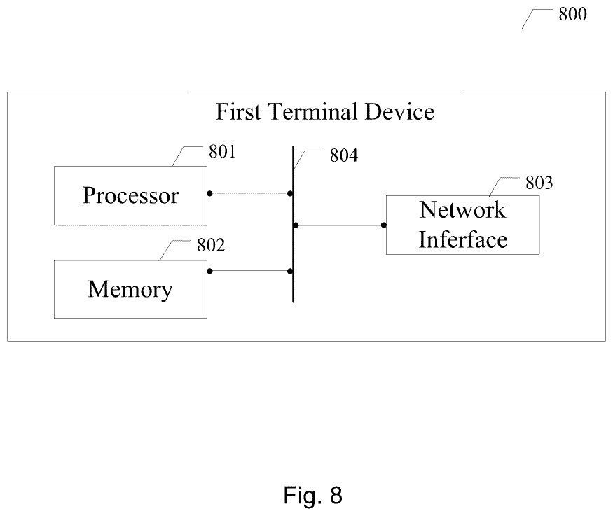

FIG. 8 is a block diagram illustrating a first terminal device 800 according to some embodiments of the present disclosure. As an example, the first terminal device 800 may act as the UE associated with the first or second embodiment illustrated in FIG. 2 or 3, but it is not limited thereto. It should be appreciated that the first terminal device 800 may be implemented using components other than those illustrated in FIG. 8.

With reference to FIG. 8, the first terminal device 800 may comprise at least a processor 801, a memory 802, a network interface 803 and a communication medium 804. The processor 801, the memory 802 and the network interface 803 may be communicatively coupled to each other via the communication medium 804.

The processor 801 may include one or more processing units. A processing unit may be a physical device or article of manufacture comprising one or more integrated circuits that read data and instructions from computer readable media, such as the memory 802, and selectively execute the instructions. In various embodiments, the processor 801 may be implemented in various ways. As an example, the processor 801 may be implemented as one or more processing cores. As another example, the processor 801 may comprise one or more separate microprocessors. In yet another example, the processor 801 may comprise an application-specific integrated circuit (ASIC) that provides specific functionality. In still another example, the processor 801 may provide specific functionality by using an ASIC and/or by executing computer-executable instructions.

The memory 802 may include one or more computer-usable or computer-readable storage medium capable of storing data and/or computer-executable instructions. It should be appreciated that the storage medium is preferably a non-transitory storage medium.

The network interface 803 may be a device or article of manufacture that enables the first terminal device 800 to send data to or receive data from other devices. In different embodiments, the network interface 803 may be implemented in different ways. As an example, the network interface 803 may be implemented as an Ethernet interface, a token-ring network interface, a fiber optic network interface, a network interface (e.g., Wi-Fi, WiMax, etc.), or another type of network interface.

The communication medium 804 may facilitate communication among the processor 801, the memory 802 and the network interface 803. The communication medium 804 may be implemented in various ways. For example, the communication medium 804 may comprise a Peripheral Component Interconnect (PCI) bus, a PCI Express bus, an accelerated graphics port (AGP) bus, a serial Advanced Technology Attachment (ATA) interconnect, a parallel ATA interconnect, a Fiber Channel interconnect, a USB bus, a Small Computing System Interface (SCSI) interface, or another type of communications medium.

In the example of FIG. 8, the instructions stored in the memory 802 may include those that, when executed by the processor 801, cause the first terminal device 800 to implement the method described with respect to FIG. 5.

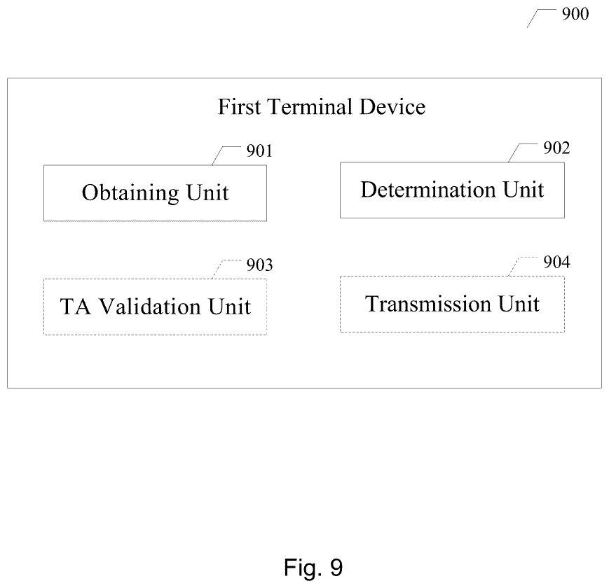

FIG. 9 is another block diagram illustrating a first terminal device 900 according to some embodiments of the present disclosure. As an example, the first terminal device 900 may act as the UE associated with the first or second embodiment illustrated in FIG. 2 or 3, but it is not limited thereto. It should be appreciated that the first terminal device 900 may be implemented using components other than those illustrated in FIG. 9.

With reference to FIG. 9, the first terminal device 900 may comprise at least an obtaining unit 901 and a determination unit 902. The obtaining unit 901 may be adapted to perform at least the operations described in the blocks 501, 502 and 503 of FIG. 5. The determination unit 902 may be adapted to perform at least the operation described in the block 504 of FIG. 5.

As an example, the first terminal device 900 may further comprise a TA validation unit 903 and a transmission unit 904. The TA validation unit 903 may be adapted to perform at least the operation described in the block 505 of FIG. 5. The transmission unit 904 may be adapted to perform at least the operation described in the block 506 of FIG. 5.

FIG. 10 is a block diagram illustrating a second terminal device 1000 according to some embodiments of the present disclosure. As an example, the second terminal device 1000 may act as the UE associated with the third embodiment illustrated in FIG. 4, but it is not limited thereto. It should be appreciated that the second terminal device 1000 may be implemented using components other than those illustrated in FIG. 10.

With reference to FIG. 10, the second terminal device 1000 may comprise at least a processor 1001, a memory 1002, a network interface 1003 and a communication medium 1004. The processor 1001, the memory 1002 and the network interface 1003 are communicatively coupled to each other via the communication medium 1004.

The processor 1001, the memory 1002, the network interface 1003 and the communication medium 1004 are structurally similar to the processor 801, the memory 802, the network interface 803 and the communication medium 804 respectively and will not be described herein in detail.

In the example of FIG. 10, the instructions stored in the memory 1002 may include those that, when executed by the processor 1001, cause the second terminal device 1000 to implement the method described with respect to FIG. 6.

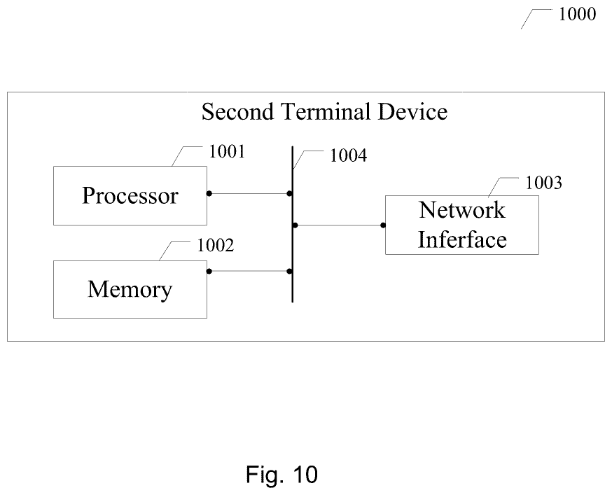

FIG. 11 is another block diagram illustrating a second terminal device 1100 according to some embodiments of the present disclosure. As an example, the second terminal device 1100 may act as the UE associated with the third embodiment illustrated in FIG. 4, but it is not limited thereto. It should be appreciated that the second terminal device 1100 may be implemented using components other than those illustrated in FIG. 11.

With reference to FIG. 11, the second terminal device 1100 may comprise at least an obtaining unit 1101, a determination unit 1102, a TA validation unit 1103 and a transmission unit 1104. The obtaining unit 1101 may be adapted to perform at least the operations described in the blocks 601 and 602 of FIG. 6. The determination unit 1102 may be adapted to perform at least the operation described in the block 603 of FIG. 6. The TA validation unit 1103 may be adapted to perform at least the operation described in the block 604 of FIG. 6. The transmission unit 1104 may be adapted to perform at least the operation described in the block 605 of FIG. 6.

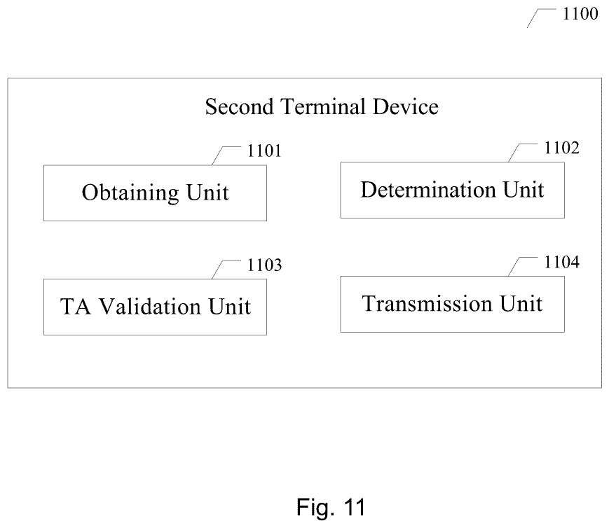

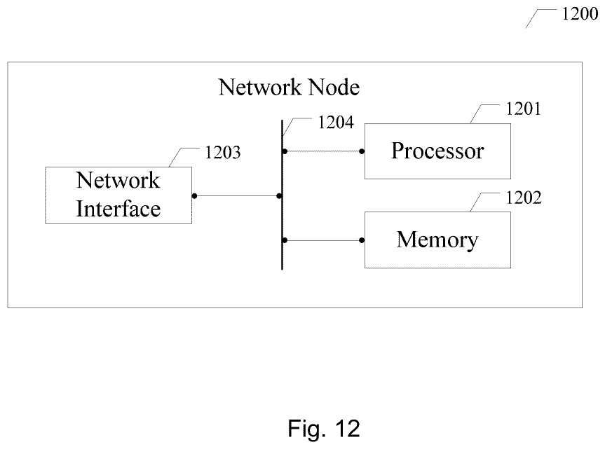

FIG. 12 is a block diagram illustrating a network node 1200 according to some embodiments of the present disclosure. As an example, the network node 1200 may act as the network node associated with the fourth embodiment, but it is not limited thereto. It should be appreciated that the network node 1200 may be implemented using components other than those illustrated in FIG. 12.

With reference to FIG. 12, the network node 1200 may comprise at least a processor 1201, a memory 1202, a network interface 1203 and a communication medium 1204. The processor 1201, the memory 1202 and the network interface 1203 are communicatively coupled to each other via the communication medium 1204.

The processor 1201, the memory 1202, the network interface 1203 and the communication medium 1204 are structurally similar to the processor 801 or 1001, the memory 802 or 1002, the network interface 803 or 1003 and the communication medium 804 or 1004 respectively and will not be described herein in detail.

In the example of FIG. 12, the instructions stored in the memory 1202 may include those that, when executed by the processor 1201, cause the network node 1200 to implement the method described with respect to FIG. 7.

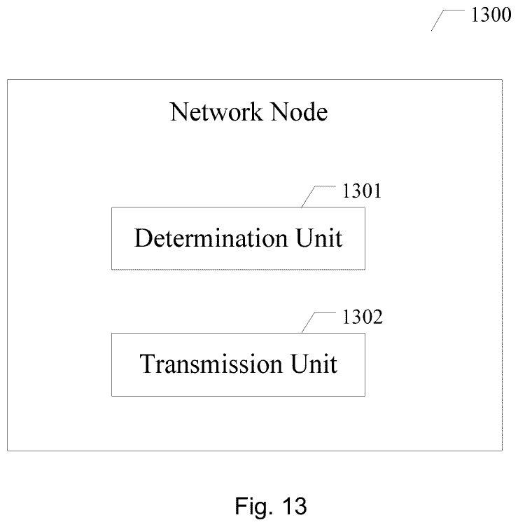

FIG. 13 is another block diagram illustrating a network node 1300 according to some embodiments of the present disclosure. As an example, the network node 1300 may provide act as the network node associated with the fourth embodiment, but it is not limited thereto. It should be appreciated that the network node 1300 may be implemented using components other than those illustrated in FIG. 13.

With reference to FIG. 13, the network node 1300 may comprise at least a determination unit 1301 and a transmission unit 1302. The determination unit 1301 may be adapted to perform at least the operation described in the block 701 of FIG. 7. The transmission unit 1302 may be adapted to perform at least the operation described in the block 702 of FIG. 7.

The units shown in FIGS. 9, 11 and 13 may constitute machine-executable instructions embodied within a machine, e.g., readable medium, which when executed by a machine will cause the machine to perform the operations described. Besides, any of these units may be implemented as hardware, such as an application specific integrated circuit (ASIC), Digital Signal Processor (DSP), Field Programmable Gate Array (FPGA) or the like.

Moreover, it should be appreciated that the arrangements described herein are set forth only as examples. Other arrangements (e.g., more controllers or more detectors, etc.) may be used in addition to or instead of those shown, and some units may be omitted altogether. Functionality and cooperation of these units are correspondingly described in more detail with reference to FIGS. 5-7.

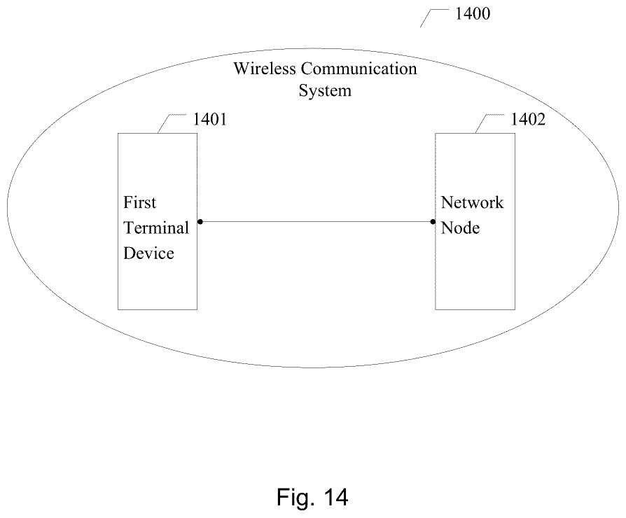

FIG. 14 is a block diagram illustrating a wireless communication system 1400 according to some embodiments of the present disclosure. The wireless communication system 1400 comprises at least a first terminal device 1401 and a network node 1402. In one embodiment, the first terminal device 1401 may act as the first terminal device 800 or 900 as depicted in FIG. 8 or 9, and the network node 1402 may act as the network node 1200 or 1300 as depicted in FIG. 12 or 13. In one embodiment, the first terminal device 1401 and the network node 1402 may communicate with each other.

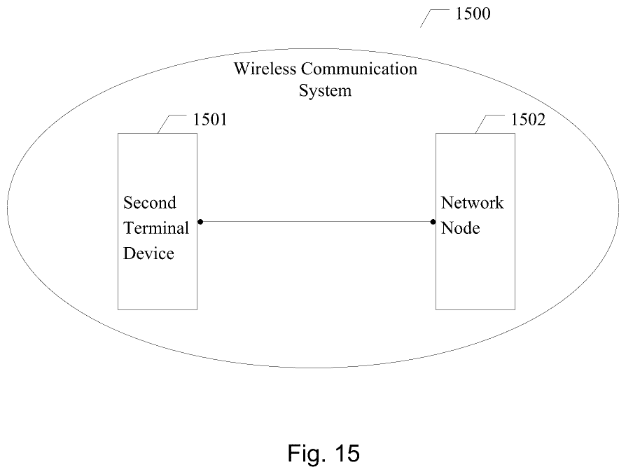

FIG. 15 is a block diagram illustrating a wireless communication system 1500 according to some embodiments of the present disclosure. The wireless communication system 1500 comprises at least a second terminal device 1501 and a network node 1502. In one embodiment, the second terminal device 1501 may act as the second terminal device 1000 or 1100 as depicted in FIG. 10 or 11, and the network node 1502 may act as the network node 1200 or 1300 as depicted in FIG. 12 or 13. In one embodiment, the second terminal device 1501 and the network node 1502 may communicate with each other.

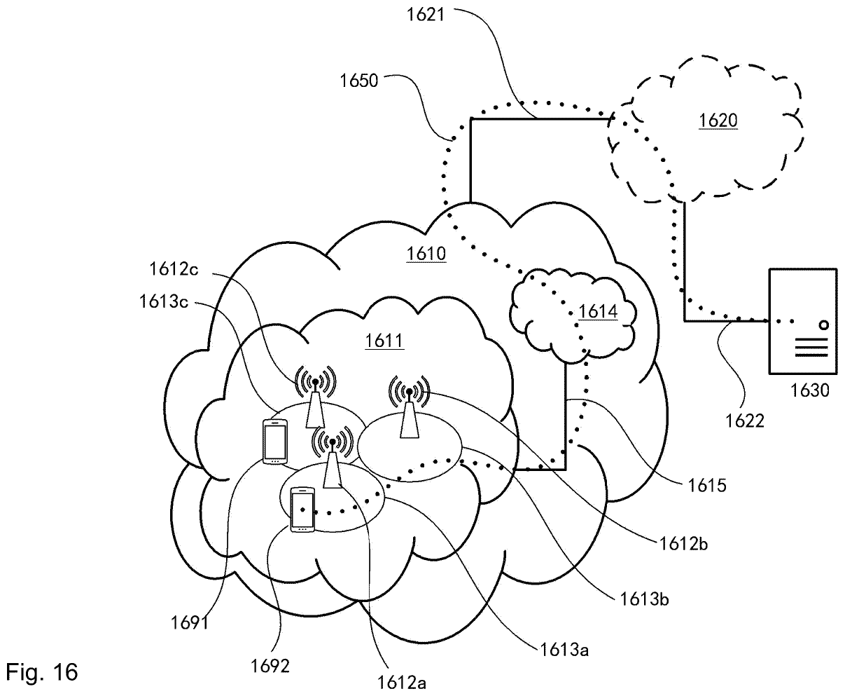

FIG. 16 is a block diagram schematically illustrating a telecommunication network connected via an intermediate network to a host computer.

With reference to FIG. 16, in accordance with an embodiment, a communication system includes a telecommunication network 1610, such as a 3GPP-type cellular network, which comprises an access network 1611, such as a radio access network, and a core network 1614. The access network 1611 comprises a plurality of base stations 1612a, 1612b, 1612c, such as NBs, eNBs, gNBs or other types of wireless access points, each defining a corresponding coverage area 1613a, 1613b, 1613c. Each base station 1612a, 1612b, 1612c is connectable to the core network 1614 over a wired or wireless connection 1615. A first user equipment (UE) 1691 located in coverage area 1613c is configured to wirelessly connect to, or be paged by, the corresponding base station 1612c. A second UE 1692 in coverage area 1613a is wirelessly connectable to the corresponding base station 1612a. While a plurality of UEs 1691, 1692 are illustrated in this example, the disclosed embodiments are equally applicable to a situation where a sole UE is in the coverage area or where a sole UE is connecting to the corresponding base station 1612.

The telecommunication network 1610 is itself connected to a host computer 1630, which may be embodied in the hardware and/or software of a standalone server, a cloud-implemented server, a distributed server or as processing resources in a server farm. The host computer 1630 may be under the ownership or control of a service provider or may be operated by the service provider or on behalf of the service provider. The connections 1621, 1622 between the telecommunication network 1610 and the host computer 1630 may extend directly from the core network 1614 to the host computer 1630 or may go via an optional intermediate network 1620. The intermediate network 1620 may be one of, or a combination of more than one of, a public, private or hosted network; the intermediate network 1620, if any, may be a backbone network or the Internet; in particular, the intermediate network 1620 may comprise two or more sub-networks (not shown).

The communication system of FIG. 16 as a whole enables connectivity between one of the connected UEs 1691, 1692 and the host computer 1630. The connectivity may be described as an over-the-top (OTT) connection 1650. The host computer 1630 and the connected UEs 1691, 1692 are configured to communicate data and/or signaling via the OTT connection 1650, using the access network 1611, the core network 1614, any intermediate network 1620 and possible further infrastructure (not shown) as intermediaries. The OTT connection 1650 may be transparent in the sense that the participating communication devices through which the OTT connection 1650 passes are unaware of routing of uplink and downlink communications. For example, a base station 1612 may not or need not be informed about the past routing of an incoming downlink communication with data originating from a host computer 1630 to be forwarded (e.g., handed over) to a connected UE 1691. Similarly, the base station 1612 need not be aware of the future routing of an outgoing uplink communication originating from the UE 1691 towards the host computer 1630.

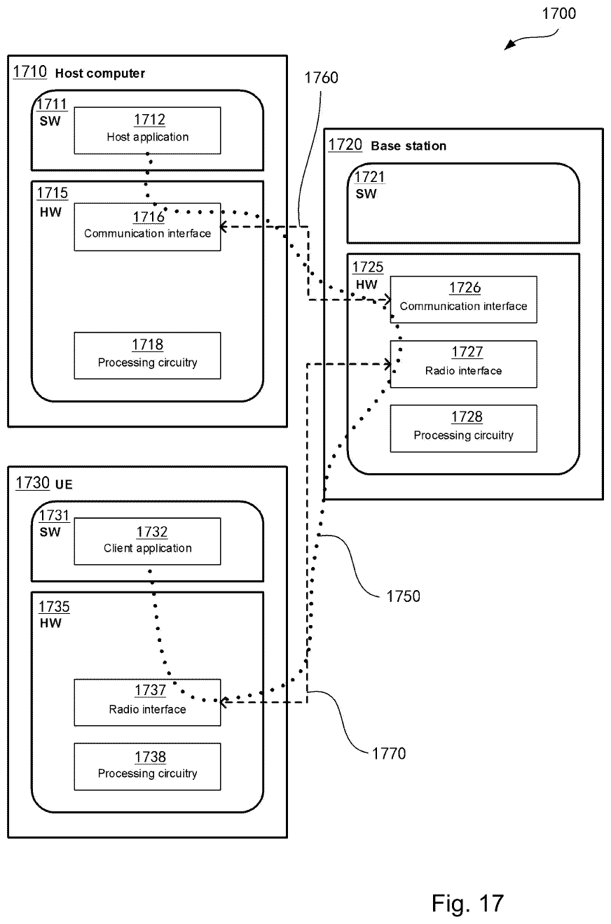

Example implementations, in accordance with an embodiment, of the UE, base station and host computer discussed in the preceding paragraphs will now be described with reference to FIG. 17. In a communication system 1700, a host computer 1710 comprises hardware 1715 including a communication interface 1716 configured to set up and maintain a wired or wireless connection with an interface of a different communication device of the communication system 1700. The host computer 1710 further comprises processing circuitry 1718, which may have storage and/or processing capabilities. In particular, the processing circuitry 1718 may comprise one or more programmable processors, application-specific integrated circuits, field programmable gate arrays or combinations of these (not shown) adapted to execute instructions. The host computer 1710 further comprises software 1711, which is stored in or accessible by the host computer 1710 and executable by the processing circuitry 1718. The software 1711 includes a host application 1712. The host application 1712 may be operable to provide a service to a remote user, such as a UE 1730 connecting via an OTT connection 1750 terminating at the UE 1730 and the host computer 1710. In providing the service to the remote user, the host application 1712 may provide user data which is transmitted using the OTT connection 1750.

The communication system 1700 further includes a base station 1720 provided in a telecommunication system and comprising hardware 1725 enabling it to communicate with the host computer 1710 and with the UE 1730. The hardware 1725 may include a communication interface 1726 for setting up and maintaining a wired or wireless connection with an interface of a different communication device of the communication system 1700, as well as a radio interface 1727 for setting up and maintaining at least a wireless connection 1770 with a UE 1730 located in a coverage area (not shown in FIG. 17) served by the base station 1720. The communication interface 1726 may be configured to facilitate a connection 1760 to the host computer 1710. The connection 1760 may be direct or it may pass through a core network (not shown in FIG. 17) of the telecommunication system and/or through one or more intermediate networks outside the telecommunication system. In the embodiment shown, the hardware 1725 of the base station 1720 further includes processing circuitry 1728, which may comprise one or more programmable processors, application-specific integrated circuits, field programmable gate arrays or combinations of these (not shown) adapted to execute instructions. The base station 1720 further has software 1721 stored internally or accessible via an external connection.

The communication system 1700 further includes the UE 1730 already referred to. Its hardware 1735 may include a radio interface 1737 configured to set up and maintain a wireless connection 1770 with a base station serving a coverage area in which the UE 1730 is currently located. The hardware 1735 of the UE 1730 further includes processing circuitry 1738, which may comprise one or more programmable processors, application-specific integrated circuits, field programmable gate arrays or combinations of these (not shown) adapted to execute instructions. The UE 1730 further comprises software 1731, which is stored in or accessible by the UE 1730 and executable by the processing circuitry 1738. The software 1731 includes a client application 1732. The client application 1732 may be operable to provide a service to a human or non-human user via the UE 1730, with the support of the host computer 1710. In the host computer 1710, an executing host application 1712 may communicate with the executing client application 1732 via the OTT connection 1750 terminating at the UE 1730 and the host computer 1710. In providing the service to the user, the client application 1732 may receive request data from the host application 1712 and provide user data in response to the request data. The OTT connection 1750 may transfer both the request data and the user data. The client application 1732 may interact with the user to generate the user data that it provides.

It is noted that the host computer 1710, base station 1720 and UE 1730 illustrated in FIG. 17 may be identical to the host computer 1630, one of the base stations 1612a, 1612b, 1612c and one of the UEs 1691, 1692 of FIG. 16, respectively. This is to say, the inner workings of these entities may be as shown in FIG. 17 and independently, the surrounding network topology may be that of FIG. 16.

In FIG. 17, the OTT connection 1750 has been drawn abstractly to illustrate the communication between the host computer 1710 and the use equipment 1730 via the base station 1720, without explicit reference to any intermediary devices and the precise routing of messages via these devices. Network infrastructure may determine the routing, which it may be configured to hide from the UE 1730 or from the service provider operating the host computer 1710, or both. While the OTT connection 1750 is active, the network infrastructure may further take decisions by which it dynamically changes the routing (e.g., on the basis of load balancing consideration or reconfiguration of the network).

The wireless connection 1770 between the UE 1730 and the base station 1720 is in accordance with the teachings of the embodiments described throughout this disclosure. One or more of the various embodiments improve the performance of OTT services provided to the UE 1730 using the OTT connection 1750, in which the wireless connection 1770 forms the last segment. More precisely, the teachings of these embodiments may improve the radio resource utilization and thereby provide benefits such as reduced user waiting time.

A measurement procedure may be provided for the purpose of monitoring data rate, latency and other factors on which the one or more embodiments improve. There may further be an optional network functionality for reconfiguring the OTT connection 1750 between the host computer 1710 and UE 1730, in response to variations in the measurement results. The measurement procedure and/or the network functionality for reconfiguring the OTT connection 1750 may be implemented in the software 1711 of the host computer 1710 or in the software 1731 of the UE 1730, or both. In embodiments, sensors (not shown) may be deployed in or in association with communication devices through which the OTT connection 1750 passes; the sensors may participate in the measurement procedure by supplying values of the monitored quantities exemplified above, or supplying values of other physical quantities from which software 1711, 1731 may compute or estimate the monitored quantities. The reconfiguring of the OTT connection 1750 may include message format, retransmission settings, preferred routing etc.; the reconfiguring need not affect the base station 1720, and it may be unknown or imperceptible to the base station 1720. Such procedures and functionalities may be known and practiced in the art. In certain embodiments, measurements may involve proprietary UE signaling facilitating the host computer's 1710 measurements of throughput, propagation times, latency and the like. The measurements may be implemented in that the software 1711, 1731 causes messages to be transmitted, in particular empty or ‘dummy’ messages, using the OTT connection 1750 while it monitors propagation times, errors etc.

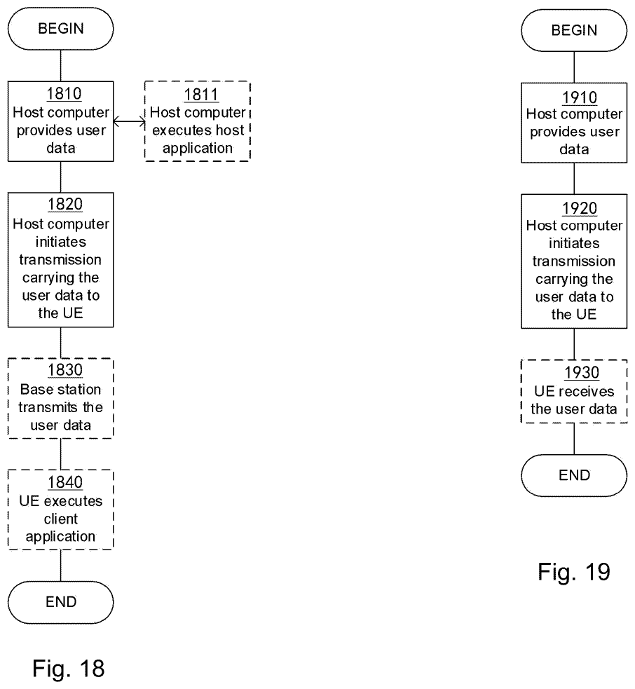

FIG. 18 is a flowchart illustrating a method implemented in a communication system, in accordance with one embodiment. The communication system includes a host computer, a base station and a UE which may be those described with reference to FIGS. 16 and 17. For simplicity of the present disclosure, only drawing references to FIG. 18 will be included in this section. In a first step 1810 of the method, the host computer provides user data. In an optional substep 1811 of the first step 1810, the host computer provides the user data by executing a host application. In a second step 1820, the host computer initiates a transmission carrying the user data to the UE. In an optional third step 1830, the base station transmits to the UE the user data which was carried in the transmission that the host computer initiated, in accordance with the teachings of the embodiments described throughout this disclosure. In an optional fourth step 1840, the UE executes a client application associated with the host application executed by the host computer.

FIG. 19 is a flowchart illustrating a method implemented in a communication system, in accordance with one embodiment. The communication system includes a host computer, a base station and a UE which may be those described with reference to FIGS. 16 and 17. For simplicity of the present disclosure, only drawing references to FIG. 19 will be included in this section. In a first step 1910 of the method, the host computer provides user data. In an optional substep (not shown) the host computer provides the user data by executing a host application. In a second step 1920, the host computer initiates a transmission carrying the user data to the UE. The transmission may pass via the base station, in accordance with the teachings of the embodiments described throughout this disclosure. In an optional third step 1930, the UE receives the user data carried in the transmission.

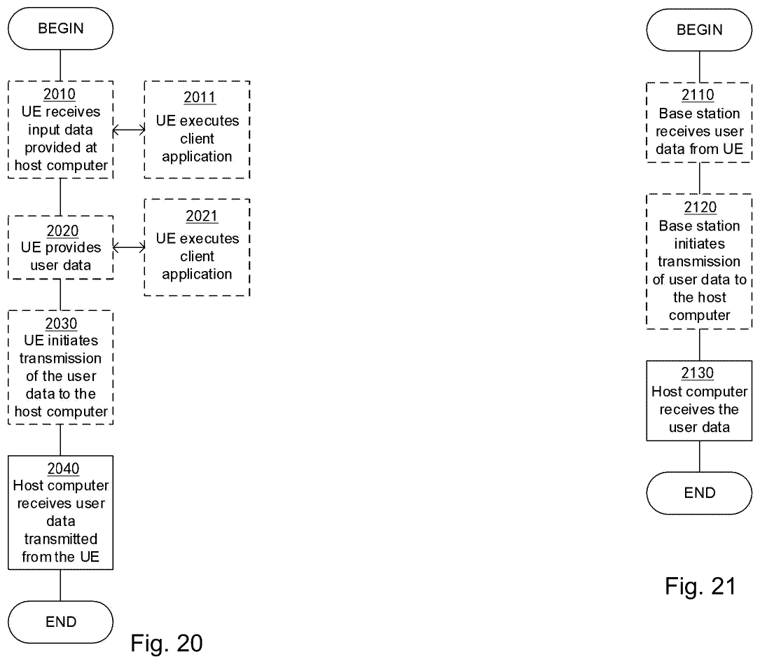

FIG. 20 is a flowchart illustrating a method implemented in a communication system, in accordance with one embodiment. The communication system includes a host computer, a base station and a UE which may be those described with reference to FIGS. 16 and 17. For simplicity of the present disclosure, only drawing references to FIG. 20 will be included in this section. In an optional first step 2010 of the method, the UE receives input data provided by the host computer. Additionally or alternatively, in an optional second step 2020, the UE provides user data. In an optional substep 2021 of the second step 2020, the UE provides the user data by executing a client application. In a further optional substep 2011 of the first step 2010, the UE executes a client application which provides the user data in reaction to the received input data provided by the host computer. In providing the user data, the executed client application may further consider user input received from the user. Regardless of the specific manner in which the user data was provided, the UE initiates, in an optional third substep 2030, transmission of the user data to the host computer. In a fourth step 2040 of the method, the host computer receives the user data transmitted from the UE, in accordance with the teachings of the embodiments described throughout this disclosure.

FIG. 21 is a flowchart illustrating a method implemented in a communication system, in accordance with one embodiment. The communication system includes a host computer, a base station and a UE which may be those described with reference to FIGS. 16 and 17. For simplicity of the present disclosure, only drawing references to FIG. 21 will be included in this section. In an optional first step 2110 of the method, in accordance with the teachings of the embodiments described throughout this disclosure, the base station receives user data from the UE. In an optional second step 2120, the base station initiates transmission of the received user data to the host computer. In a third step 2130, the host computer receives the user data carried in the transmission initiated by the base station.

Some portions of the foregoing detailed description have been presented in terms of algorithms and symbolic representations of transactions on data bits within a computer memory. These algorithmic descriptions and representations are ways used by those skilled in the data processing arts to most effectively convey the substance of their work to others skilled in the art. An algorithm is here, and generally, conceived to be a self-consistent sequence of transactions leading to a desired result. The transactions are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be appreciated, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to actions and processes of a computer system, or a similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general-purpose systems may be used with programs in accordance with the teachings herein, or it may prove convenient to construct more specialized apparatus to perform the required method transactions. The required structure for a variety of these systems will appear from the description above. In addition, embodiments of the present disclosure are not described with reference to any particular programming language. It should be appreciated that a variety of programming languages may be used to implement the teachings of embodiments of the present disclosure as described herein.

An embodiment of the present disclosure may be an article of manufacture in which a non-transitory machine-readable medium (such as microelectronic memory) has stored thereon instructions (e.g., computer code) which program one or more data processing components (generically referred to here as a “processor”) to perform the operations described above. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

In the foregoing detailed description, embodiments of the present disclosure have been described with reference to specific exemplary embodiments thereof. It will be evident that various modifications may be made thereto without departing from the spirit and scope of the present disclosure as set forth in the following claims. The specification and drawings are, accordingly, to be regarded in an illustrative sense rather than a restrictive sense.

Throughout the description, some embodiments of the present disclosure have been presented through flow diagrams. It should be appreciated that the order of transactions and transactions described in these flow diagrams are only intended for illustrative purposes and not intended as a limitation of the present disclosure. One having ordinary skill in the art would recognize that variations can be made to the flow diagrams without departing from the spirit and scope of the present disclosure as set forth in the following claims.

1. A method implemented by a first terminal device, the method comprising:
obtaining information about a first set of beams associated with configured resources for data transmission from a network node;
obtaining a signal level threshold from the network node; and
determining a second set of beams from the first set of beams based on at least the signal level threshold.

2. The method of claim 1, wherein the configured resources comprise a configured grant, CG, configuration for small data transmission, SDT.

3. The method of claim 1, wherein the information comprises beam indices, beam configuration patterns and/or frequency ranges.

4. The method of claim 1, further comprising:
performing time alignment, TA, validation using beams in the second set of beams; and
transmitting data using configured resources associated with the beams in the second set of beams in the case that the TA is valid.

5. The method of claim 4, wherein the TA validation is based on one or more of a beam level reference signal receiving power, RSRP, change, a cell level RSRP change, and a TA timer associated with the TA.

6. The method of claim 4, wherein in the case that the TA is invalid, the data is not transmitted using the configured resources associated with the beams in the second set of beams.

7. The method of claim 4, further comprising:
in the case that the TA is invalid, performing the TA validation using beams in the first set of beams.

8. The method of claim 1, wherein the second set of beams is determined by:
comparing a signal level of each beam in the first set of beams to the signal level threshold; and
including a beam having a signal level above the signal level threshold in the second set of beams.

9. The method of claim 8, wherein the signal level includes a signal strength or a signal quality.

10. The method of claim 8, wherein the signal level is measured by the first terminal device periodically.

11. The method of claim 1, wherein the second set of beams is determined only when the first terminal device is operating in one of one or more power saving modes.

12. The method of claim 11, further comprising:
in the case that the first terminal device is not operating in any of the power saving modes, performing the TA validation using beams in the first set of beams.

13. The method of claim 11, wherein conditions in which the first terminal device is in a power saving mode include low mobility, not-at-cell edge, or both low mobility and not-at-cell edge.

14. The method of claim 1, wherein the second set of beams is determined periodically.

15. The method of claim 1, wherein the second set of beams is determined when the first terminal device is configured for the data transmission.

16. The method of claim 1, wherein the second set of beams is determined only when the first terminal device is triggered to perform the TA validation.

17. The method of claim 1, wherein the second set of beams is determined when signal levels of one or more beams of the first set of beams have changed by a predetermined margin.

18. The method of claim 1, wherein the second set of beams is determined when the first terminal device meets criteria for entering any type of power saving mode or a predetermined type of power saving mode.

19. The method of claim 1, wherein the second set of beams is determined when the first terminal device meets criteria for exiting from any type of power saving mode or a predetermined type of power saving mode.

20. The method of claim 1, wherein the second set of beams is a subset of the first set of beams.

21.-23. (canceled)

24. A method implemented by a second terminal device, the method comprising:
obtaining information about a first set of beams associated with first configured resources for data transmission from a network node;
obtaining information about a second set of beams associated with second configured resources for the data transmission from the network node;
determining whether the second terminal device is in a power saving mode;
performing time alignment, TA, validation using beams in the first set of beams in response to determination that the second terminal device is not in the power saving mode, and using beams in the second set of beams in response to determination that the second terminal device is in the power saving mode; and
transmitting data using first configured resources associated with the first set of beams and using second configured resources associated with the second set of beams in the case that the TA is valid.

25.-46. (canceled)

47. A first terminal device, comprising:
a processor; and
a memory communicatively coupled to the processor and adapted to store instructions which, when executed by the processor, cause the first terminal device to perform operations of the method of claim 1.

48. (canceled)

49. A second terminal device, comprising:
a processor; and
a memory communicatively coupled to the processor and adapted to store instructions which, when executed by the processor, cause the second terminal device to perform operations of the method claim 24.

50.-57. (canceled)
